(19) United States
(12) Patent Application Publication
(10) Pub. No.: US 2009/0078107 A1
(43) Pub. Date: Mar. 26, 2009

(54) Keyboard Apparatus of Electronic Musical Instrument

(75) Inventor: Ichiro OSUGA, Hamamatsu-Shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 12/211,678

(22) Filed: Sep. 16, 2008

(30) Foreign Application Priority Data
Sep. 21, 2007 (JP) 2007-245105
Sep. 21, 2007 (JP) 2007-254104

(51) Int. Cl. G10C 3/12

(52) U.S. Cl. 84/423 R

(57) ABSTRACT

Keys 1, 2 are supported by a frame 3 in a freely swingable manner. Massive bodies 8, a lower limit stopper 10 and an upper limit stopper 11 are situated below keys 1, 2. Massive bodies 8 are supported by a frame 3 in a freely swingable manner and pivot in synchronization with key-depression. A lower limit stopper 10 restricts a lower limit of pivoting range of the massive bodies 8. An upper limit stopper 10 restricts an upper limit of pivoting range of the massive bodies 8. Fixing portions (erected potions) 3g1 for fixing the upper limit stopper 11 are provided on the frame 3 in one-to-one corresponding with keys 1, 2. The upper limit stopper 11 is fixed to the undersurface of the fixing portions 3g. An upper part of each fixing portion 3g is situated inside right and left side walls of each key 1, 2.

### BACKGROUND OF THE INVENTION

1. Field of the Invention

The present invention relates to a keyboard apparatus of an electronic musical instrument, the keyboard apparatus having massive bodies which pivot in synchronization with key-depression.

2. Description of the Related Art

Conventionally, a keyboard apparatus of an electronic musical instrument is designed such that massive bodies pivot in synchronization with key-depression in order to provide its players with the feeling of key touch, more specifically, the feeling of mass and the feeling of stop similar to those offered by a keyboard mechanism of an acoustic piano.

A keyboard apparatus disclosed in Japanese Unexamined Patent Publication No. H9-198037 has an upper surface board provided on a rear part of a casing which accommodates the rear end (key fulcrum) of respective key main bodies. To the undersurface of the upper surface board, a stopper (upper limit stopper) is fixed. Bent portions (mass concentrated portions, free ends) of spindles (massive bodies) extend far behind the rear end of the key main bodies. At the time of key-depressions, the bent portions collide with the upper limit stopper. According to this structure, the depth of the keyboard apparatus has to be large. Furthermore, the stroke length of the free end increases with increase in the distance from a fulcrum of the spindle to the free end. Therefore, unless the angle at which the massive bodies pivot is reduced, the height of the keyboard apparatus is made high.

In Japanese Unexamined Patent Publication No. H4-142595 and Japanese Examined Patent Publication No. H2-019468, keyboard apparatuses in which the above-described massive bodies are placed below the keys are disclosed. In these cases, the depth of the keyboard apparatuses is the same as that of a keyboard apparatus having no massive bodies.

In the keyboard apparatus disclosed in Japanese Unexamined Patent Publication No. H4-142595, hammer arms (massive bodies) are provided on the undersurface of a keyboard chassis (frame) situated in front of axes (key fulcrums). However, the height of the keyboard apparatus is obtained by adding a sidewall of a key, a stroke length of a key, a clearance between a key and the keyboard chassis, a thickness of the keyboard chassis, a thickness of a stopper member (upper limit stopper), a stroke length of a hammer arm, a height of a hammer arm, a thickness of a damping member (lower limit stopper), and the like. By providing the hammer arms, therefore, a problem that the shape of the keyboard apparatus becomes higher to make the electronic musical instrument bulky arises.

In the keyboard apparatus disclosed in Japanese Examined Patent Publication No. H2-019468, axes (pivot fulcrums) of respective arms (massive bodies) are fit into concave portions provided on right and left side walls of the respective keys, with cushion members (upper limit stoppers) of the arms being provided on a ceiling surface located inside the respective keys. When a key is depressed, the arm gets into the inside sandwiched between the right and left side walls of the key. Therefore, because unused space which is situated inside the right and left side walls of the respective keys is utilized, the height of the keyboard apparatus can be reduced. However, because the cushion member is placed inside the respective keys, a problem that a shock caused by collision of the arm with the cushion member is perceived by a player with his finger through a key arises. In addition, because the cushion member has to be provided for the individual keys, a problem that the conventional apparatus decreases the efficiency of assembly to require more assembly cost, compared with a case where all the keys share a cushion member.

### DISCLOSURE OF THE INVENTION

### Problems to Be Solved by the Invention

The present invention was accomplished to solve the above-described problems, and an object thereof is to provide a keyboard apparatus of an electronic musical instrument having massive bodies which pivot in synchronization with key-depression, the keyboard apparatus having a reduced height of the apparatus without the need for increasing the depth of the apparatus, and offering a favorable feeling of stop to a player.

It is a feature of the present invention to provide a keyboard apparatus of an electronic musical instrument, the keyboard apparatus including a plurality of keys; a plurality of massive bodies situated below the plurality of keys in a one-to-one correspondence with the keys, each massive body pivoting in synchronization with key-depression of its corresponding key; a frame on which the plurality of keys and the plurality of massive bodies are arranged in parallel; an upper limit stopper member which is placed below the plurality of keys to be fixed to the frame side such that a collision of each massive body with the upper limit stopper member results in restriction on upper limit of pivoting range of the each massive body; a lower limit stopper member which is placed below the plurality of keys to be fixed to the frame side such that a collision of each massive body with the lower limit stopper member results in restriction on lower limit of pivoting range of the each massive body; and a plurality of fixing portions provided on the frame in a one-to-one correspondence with the plurality of keys, at least an upper part of each fixing portion being situated inside right and left side walls of its corresponding key, each fixing portion having an undersurface to which the upper limit stopper member is fixed.

According to the feature of the present invention, the plurality of massive bodies, the upper limit stopper member and the lower limit stopper member are situated below the plurality of keys, resulting in the need for increasing the depth of the apparatus being eliminated. In addition, the fixing portions are provided not on the key main body side but on the frame side, resulting in a favorable feeling of stop being offered to the player. In order to provide the fixing portions, the unused inner space between the right and left side walls of each key is efficiently used. As a result, the overlaying of each fixing portion with the right and left side walls of its corresponding key contributes reduction in height of the keyboard apparatus. Furthermore, in a case where even the undersurface of each fixing portion is provided inside the right and left side walls of each key, the position of the respective fixing portions is raised, compared to the conventional case where the fixing portions are provided on the frame side. As a result, the height of the keyboard apparatus according to the feature can be reduced, compared to the conventional case.

Consequently, the outside shape of the electronic musical instrument equipped with the keyboard apparatus can be thinned. In a case where the electronic musical instrument is designed to have the same height as a conventional electronic musical instrument, the electronic musical instrument according to the present invention can expand space provided on an upper portion located behind the keys of the keyboard apparatus for implementing functional parts of the electronic musical instrument such as switches provided on an operating panel and indicators.

It is another feature of the present invention that, in the above-described configuration, each of the plurality of fixing portions has a vertical rib situated on an upper surface side of the each fixing portion. According to the feature, because the vertical rib increases stiffness of the fixing portion, a collision of a massive body with the upper limit stopper member causes less deformation of the fixing portion, resulting in an improved feeling of stop being delivered to a finger of the player.

It is still another feature of the present invention that, in the above-described configuration, the undersurface of the each fixing portion is situated below lower end surface of right and left side walls of its corresponding key even in a state where the corresponding key has been depressed. The upper limit stopper member is shaped like a ribbon whose longitudinal direction coincides with a direction in which the plurality of keys are arranged, and continuously extends over at least two neighboring keys to be fixed to the undersurface of the respective fixing portions provided for the at least two keys. Accordingly, the upper limit stopper member is fixed to the undersurface of the respective fixing portions of at least two neighboring keys which correspond to all the keys of the keyboard, keys included in an octave to a few octaves, etc. As a result, compared with a case where the action restricting member is provided for each fixing portion to be fixed separately, the feature of the present invention improves the efficiency of assembly of the keyboard apparatus.

It is a further feature of the present invention to provide a keyboard apparatus of an electronic musical instrument, the keyboard apparatus including a plurality of keys; a plurality of massive bodies situated below the plurality of keys in a one-to-one correspondence with the keys, each massive body pivoting in synchronization with key-depression of its corresponding key; a frame on which the plurality of keys and the plurality of massive bodies are arranged in parallel; an upper limit stopper member which is placed below the plurality of keys to be fixed to the frame side such that a collision of each massive body with the upper limit stopper member results in restriction on upper limit of pivoting range of the each massive body; and a lower limit stopper member which is placed below the plurality of keys to be fixed to the frame side such that a collision of each massive body with the lower limit stopper member results in restriction on lower limit of pivoting range of the each massive body. The each massive body has a first contact portion which comes into contact with the upper limit stopper member in a state where a key corresponding to the each massive body has been depressed and a second contact portion which comes into contact with the lower limit stopper member in a state where the corresponding key has been released. The first contact portion is situated close to a free end of the each massive body with the second contact portion being situated closer to a pivot fulcrum side of the each massive body than the first contact portion. The second contact portion is situated in a position higher than the lowest end of the first contact portion in a state where the key corresponding to the each massive body has been released.

According to the feature as well, the plurality of massive bodies, the upper limit stopper member and the lower limit stopper member are situated below the plurality of keys, resulting in the need for increasing the depth of the apparatus being eliminated. In addition, in a state where the corresponding key has been depressed, the first contact portion which comes into contact with the upper limit stopper member placed on the frame side is situated in the vicinity of the free end (“vicinity” can include and exclude the free end), resulting in a favorable feeling of stop being offered to the player. Because collision of each massive body with the lower limit stopper member is caused only by gravity without any key-depression force, an impact brought about by the collision is small. Therefore, although the second contact part which comes into contact with the lower limit stopper member is situated on the pivot fulcrum side of the massive body, deformation of the massive body will not present any problem at the collision of the massive body with the lower limit stopper member. Because the second contact portion is situated in a position higher than the lowest end of the first contact portion in the state where the key has been released, the height of the apparatus will not be raised due to the thickness of the lower limit stopper member.

Consequently, the outside shape of the electronic musical instrument equipped with the keyboard apparatus can be thinned. In a case where the electronic musical instrument is designed to have the same height as a conventional electronic musical instrument, the electronic musical instrument according to the present invention can expand space provided on an upper portion located behind the keys of the keyboard apparatus for implementing functional parts of the electronic musical instrument such as switches provided on an operating panel and indicators.

It is a still further feature of the present invention that, in the above-described configuration, the each massive body is designed such that an upper portion of the each massive body is situated inside right and left side walls of the key corresponding to the each massive body in a state where the corresponding key has been depressed. According to the feature, the free space which is situated inside the right and left side walls of each key main body is efficiently used to increase the mass of each massive body in accordance with the overlaying of each massive body with the right and left side walls of each key, resulting in increased inertial moment of each massive body.

It is another feature of the present invention that, in the above-described configuration, the each massive body has a concave portion which is open downward such that a ceiling surface of the concave portion serves as the second contact portion to come into contact with the lower limit stopper member in a state where the corresponding key has been released. According to the feature, the mass placed on the front and the rear of the concave portion is effectively used to increase the inertial moment. As long as each massive body is configured by connecting the pivot fulcrum to the mass concentrated portion through the connecting portion, the above-described concave portion can be placed on the mass concentrated portion.

### BRIEF DESCRIPTION OF THE DRAWINGS

FIG. 1A is a right side view schematically showing a keyboard apparatus of an electronic musical instrument, the keyboard apparatus being a first embodiment of the present invention;

FIG. 1B is a right side view of the keyboard apparatus shown in FIG. 1A, the keyboard apparatus being in a state where a white key has been depressed;

FIG. 1C is a vertical section view showing a white key main body and a black key main body shown in FIG. 1B when viewed along an arrow C-C;

FIG. 2A is a right side view schematically showing a keyboard apparatus of an electronic musical instrument, the keyboard apparatus being a second embodiment of the present invention;

FIG. 2B is a right side view of the keyboard apparatus shown in FIG. 2A, the keyboard apparatus being in a state where a white key has been depressed;

FIG. 2C is a vertical section view showing the white key main body and the black key main body shown in FIG. 2B when viewed along an arrow C-C;

FIG. 2D is a vertical section view showing the white key main body and the black key main body shown in FIG. 2B when viewed along an arrow D-D;

FIG. 3A is a right side view schematically showing a keyboard apparatus of an electronic musical instrument, the keyboard apparatus being a third embodiment of the present invention;

FIG. 3B is a right side view of the keyboard apparatus shown in FIG. 3A, the keyboard apparatus being in a state where a white key has been depressed;

FIG. 3C is a vertical section view showing the white key main body and the black key main body shown in FIG. 3B when viewed along an arrow C-C;

FIG. 4A is a right side view schematically showing a keyboard apparatus of an electronic musical instrument, the keyboard apparatus being a fourth embodiment of the present invention;

FIG. 4B is a right side view of the keyboard apparatus shown in FIG. 4A, the keyboard apparatus being in a state where a white key has been depressed;

FIG. 4C is a vertical section view showing the white key main body and the black key main body shown in FIG. 4B when viewed along an arrow C-C;

FIG. 5A is a right side view schematically showing a keyboard apparatus of an electronic musical instrument, the keyboard apparatus being a fifth embodiment of the present invention;

FIG. 5B is a right side view of the keyboard apparatus shown in FIG. 5A, the keyboard apparatus being in a state where a white key has been depressed;

FIG. 5C is a vertical section view showing the white key main body and the black key main body shown in FIG. 5B when viewed along an arrow C-C;

FIG. 6A is a right side view schematically showing a keyboard apparatus of an electronic musical instrument, the keyboard apparatus being a sixth embodiment of the present invention; and

FIG. 6B is a right side view of the keyboard apparatus shown in FIG. 6A, the keyboard apparatus being in a state where a white key has been depressed.

### DESCRIPTION OF THE PREFERRED EMBODIMENT

### a. First Embodiment

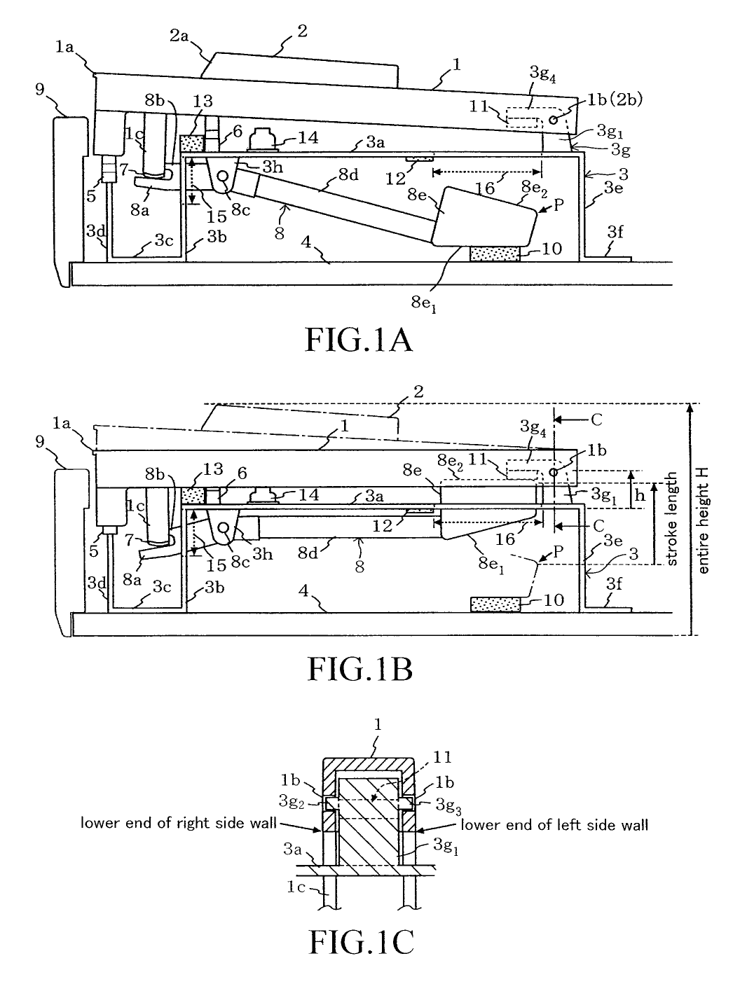

FIG. 1A and FIG. 1B are right side views schematically showing a keyboard apparatus of an electronic musical instrument, the keyboard apparatus being a first embodiment of the present invention. FIG. 1A shows a state (key-release state) in which a key has not been depressed. FIG. 1B shows a state in which a white key main body 1 has been depressed. FIG. 1C is a vertical section view schematically showing the white key main body 1 and a key frame 3 shown in FIG. 1B when viewed along an arrow C-C.

This keyboard apparatus has the white key main bodies 1, black key main bodies 2, the key frame 3, a key frame bottom board 4 and massive bodies 8. The key frame 3 extends in a direction in which the plurality of keys are arranged. The key frame 3 is made of sheet metal or synthetic resin, for example. Respective parts (having alphabetical subscripts) of the key frame 3 are molded in one piece. On an upper mount portion 3a of the key frame 3, the plurality of white key main bodies 1 and the plurality of black key main bodies 2 are arranged in parallel. In the shown example, the upper mount portion 3a is horizontal and has a step portion 3b. The step portion 3b is placed at the front part in the longitudinal direction (depth direction) of the keys. The step portion 3b has a plurality of penetrating holes 15 shaped like slits. The plurality of penetrating holes 15 correspond to the plurality of keys.

The key frame 3 has a base portion 3c placed forward of the step portion 3b. The base portion 3c is provided in order to mount the key frame 3 on the key frame bottom board 4. A vertical wall 3d is placed forward of the base portion 3c. On the vertical wall 3d, a plurality of key guides 5 are provided. The respective key guides 5 are inserted into a lower part of a tip 1a of the respective white key main bodies 1. A plurality of key guides 6 provided for the black key main bodies 2 are erected on the upper mount portion 3a. The lower part of the tips 1a of the white key main bodies, the key guides 5, the vertical wall 3d and the front of the key frame bottom board 4 are covered with a mouth stick 9.

The upper mount portion 3a has a step portion 3e. The step portion 3e is placed at the rear part in the longitudinal direction of the keys. The key frame 3 has a base portion 3f placed behind the step portion 3e. The base portion 3f is provided in order to mount the key frame 3 on the key frame bottom board 4. On a top surface of the vicinity of the rear end of the upper mount portion 3a, a plurality of supporting portions 3g are arranged so as to correspond to the plurality of white key main bodies 1 and the plurality of black key main bodies 2. The respective supporting portions 3g support the respective keys in a freely swingable manner. Each of the supporting portions 3g has an erected portion 3g1 and a forward overhanging portion 3g4. The erected portion 3g1 protrudes upward from the upper mount portion 3a. On the rear of the upper mount portion 3a, a plurality of penetrating holes 16 shaped like slits are provided forward of the supporting portions 3g to correspond to the respective keys.

As shown in FIG. 1C, each of the supporting portions 3g has axis portions 3g2, 3g3 provided on the upper part of the right and left side surfaces. The axis portions 3g2, 3g3 overhang in the direction in which the keys are arranged. Into the axis portions 3g2, 3g3, a key fulcrum 1b (penetrating hole) provided on the right and left side walls of the rear end of the white key main body 1 is fitted. Supporting portions 3g which are not shown and correspond to the black key main bodies 2 are configured similarly. Into the axis portions 3g2, 3g3, more specifically, a key fulcrum 2b (penetrating hole) provided on the right and left side walls of the rear end of the black key main body 2 is fitted.

An upper part of the erected portion 3g1 shown in FIG. 1A horizontally overhangs frontward to have the flat-shaped forward overhanging portion (fixing portion) 3g4. To the undersurface (in the shown example, the horizontal surface) of the forward overhanging portion 3g4, an upper limit stopper (upper limit stopper member) 11 is fixed. Inside the right and left side walls of the white key main body 1 and the black key main body 2, there is space situated inside the key, the space being open downward. The forward overhanging portion 3g4 and the upper limit stopper 11 provided for each white key main body 1 and black key main body 2 are situated inside the right and left side walls of the white key main body 1 or the black key main body 2. More specifically, the forward overhanging portion 3g4 and the upper limit stopper 11 are provided so as to be overlaid with the right and left side walls of the white key main body 1 or the black key main body 2 without interfering with the right and left side walls of the white key main body 1 or the black key main body 2.

On the upper surface of the upper mount portion 3a of the key frame 3, a plurality of key switches 14 are arranged. Opposed to the plurality of key switches 14, a protruding portion (actuator) is provided in the space situated inside the right and left side walls of each of the white key main bodies 1 and the black key main bodies 2. More specifically, the protruding portion protrudes downward from the undersurface of the top surface of each key. In FIG. 1C as well, the protruding portion is not shown. On the undersurface of the upper mount portion 3a, massive body supporting portions 3h are erected in the vicinity of the front end of the upper mount portion 3a. The shown massive body supporting portion 3h is provided for the white key main body 1. Downward from the lower end of the right and left side walls of the vicinity of the tip 1a of the white key main body, a force conveying portion 1c extends. A tip of the force conveying portion 1c has a bottom board. An upper portion of the bottom board penetrates in the longitudinal direction of the key. To the upper surface and the undersurface of the bottom board, an elastic member 7 is fixed.

A force conveying portion of the black key main body 2 is not shown but extends downward from a tip 2a of the black key main body. The lower end of the force conveying portion of the black key main body 2 faces frontward. The position of the force conveying portions of the black key main bodies 2 is overlaid with that of the force conveying portions 1c in the direction in which the keys are arranged. For each of the black key main bodies 2 as well, a similar massive body pivotably supported by a massive body supporting portion is similarly provided. Each of the massive bodies provided for the black key main bodies 2 is engaged with the bottom board of the force conveying portion of the corresponding black key main body 2 through the elastic member. The respective white key main bodies 1 and black key main bodies 2 recover to their respective original positions because of the self weight of their corresponding massive body 8. Between the white key main bodies 1 and the key frame 3, and between the black key main bodies 2 and the key frame 3, however, recovery springs for recovering the white key main bodies 1 and the black key main bodies 2 to their key-release positions may be provided, respectively.

The plurality of massive bodies 8, a lower limit stopper 10 and the upper limit stoppers 11 are situated below (including the space situated inside the respective keys) the plurality of white key main bodies 1 and the plurality of black key main bodies 2 (keyboard surface). The respective massive bodies 8 correspond to the respective white key main bodies 1 and the black key main bodies 2. Each massive body 8 pivots in synchronization with a key-depression of its corresponding key main body. The shown massive body 8 is provided for the white key main body 1. The massive body 8 has a pivot fulcrum 8c supported by the massive body supporting portion 3h, a main driven portion 8a and a secondary driven portion 8b which are bifurcated and installed forward of the pivot fulcrum 8c to be engaged with the force conveying portion 1c of the key through the elastic member 7, and a mass concentrated portion 8e which is situated behind the pivot fulcrum 8c with a connecting portion 8d sandwiched in between and serves as a free end.

The rear end of the connecting portion 8d is connected to the lower portion of the front end of the mass concentrated portion 8e. The width of the mass concentrated portion 8e along the arranged keys is smaller than the inner width between the right and left side walls of each key. A shown point P is a point which is the furthest from the pivot fulcrum 8c. In this specification, such a point is referred to as a free end. The connecting portion 8d and the mass concentrated portion 8e produce a large inertial moment when pivoting. The massive body 8 penetrates the penetrating hole 15 between the driven portion 8a, 8b and the pivot fulcrum 8c. In the shown example, a lower end surface 8e1 of the mass concentrated portion 8e is kept horizontal. The lower end surface 8e1 serves as a contact part which comes into contact with the lower limit stopper 10 (lower limit stopper member). The lower limit stopper 10 is fastened to the upper surface of the key frame bottom board 4. In the shown example, an upper end surface 8e2 of the mass concentrated portion 8e is an inclined surface where the rear is lower than the front. As shown in FIG. 1B, however, the upper end surface 8e2 becomes horizontal when the key has been depressed.

In the key-release state shown in FIG. 1A where the key has been released, if the key main body (in the shown example, the white key main body 1) is depressed, the massive body 8 corresponding to the key pivots counterclockwise in spite of gravity. The upper end surface 8e2 of the mass concentrated portion 8e passes through the penetrating hole 16. During this, a counteraction according to the inertial moment of the massive body 8 is conveyed to the white key main body 1, resulting in a feeling of mass being delivered to a finger of a player. As shown in FIG. 1B, the connecting portion 8d of the massive body becomes horizontal to collide the upper end surface 8e2 of the mass concentrated portion 8e with the upper limit stopper (upper limit stopper member) 11, resulting in restriction on the upper limit of the pivoting massive body 8. Because the restriction on the pivoting of the massive body 8 also involves damping of the massive body 8, the player will recognize a feeling of stop with his finger through the key. The free end P of the mass concentrated portion 8e is to travel a distance shown in FIG. 1B as “stroke length”.

The above-described forward overhanging portion 3g4 is provided not on the white key main body 1 and the black key main body 2 side but on the key frame 3 side. Therefore, an impact caused by a collision of the upper end surface 8e2 of the mass concentrated portion with the upper limit stopper 11 will not be conveyed to a finger of the player through the key. The forward overhanging portions 3g4 can have a thickness larger than that of the upper mount portion 3a of the key frame. In addition, the erected portions 3g1 can have high stiffness. Furthermore, the erected portions 3g1 are placed near the step portion 3e. As a result, such a structure makes it easy to prevent deformation (distortion) of the forward overhanging portions 3g4 to which the upper limit stopper 11 is fixed.

On the undersurface of the upper mount portion 3a of the key frame 3, an auxiliary stopper 12 is provided so as to adjoin to the front end of the penetrating hole 16 in the shown example. If a key-depression causes the massive body 8 to transiently exceed (over-stroke) the upper limit (fully depressed standstill position) of the pivoting of the massive body 8, the auxiliary stopper 12 prevents collision of the connecting portion 8d with the upper mount portion 3a of the key frame. In a case where there is no possibility of collision of the connecting portions 8d with the upper mount portion 3a of the key frame 3, however, the auxiliary stopper 12 is not necessary.

If the player releases the key, the massive body 8 pivots in a reverse direction because of its self weight to return to the position shown in FIG. 1A. As a result, the lower end surface 8e1 of the mass concentrated portion 8e collides with the lower limit stopper 10, resulting in the initial position of the massive body 8 (key-release state) being defined. Because the lower end surface 8e1 of the mass concentrated portion 8e in which the mass of the massive body 8 concentrates has a contact part (the second contact part) which comes into contact with the lower limit stopper 10, deterioration in the feeling of stop such as rebound and vibration at the time of key-release can be reduced.

When the white key main body 1 or the black key main body 2 is depressed, on the other hand, a lower limit stopper 13 provided on the upper surface of the front part of the upper mount portion 3a of the key frame restricts lower limit of the lower end of the right and left side walls of the depressed white key main body 1 or black key main body 2. By arranging the above-described lower limit stopper 10, auxiliary stopper 12 and lower limit stopper 13 like ribbons along the arranged keys, the lower limit stopper 10, the auxiliary stopper 12 and the lower limit stopper 13 can be shared by all the keys or by a plurality of keys included in an octave or a few octaves.

The conventional massive body disclosed in Japanese Unexamined Patent Publication No. H4-142595 described above comes into contact with an upper limit stopper fastened to the undersurface of a key frame when a corresponding key is depressed. In the first embodiment, unlike the conventional structure, the upper limit stopper 11 is provided on the undersurface of the forward overhanging portion 3g4 which is located in a position higher than the undersurface of the upper mount portion 3a. As a result, the position of the upper limit stopper 11 is displaced upward by a distance h shown in FIG. 1B. The displacement of the position of the upper limit stopper 11 also involves upward displacement of the massive body 8 and the lower limit stopper 10 compared to the conventional structure, resulting in the arrangement shown in FIGS. 1A to 1C. More specifically, the height of the upper mount portion 3a is lowered by the distance h compared to the conventional art. Consequently, the reduction in the height of the upper mount portion 3a contributes reduction in the entire height H of the keyboard apparatus when compared to the conventional art.

The above-described reduction can be achieved as long as the undersurface of the forward overhanging portions 3g4 is located in a position higher than the undersurface of the upper mount portion 3a of the key frame. In the first embodiment, however, in order to place the upper limit stoppers 11 at a position higher than the undersurface of the upper mount portion 3a of the key frame 3 as much as possible, the forward overhanging portions 3g4 are provided inside the right and left side walls of the respective white key main bodies 1 and the black key main bodies 2 (space in a direction of height of the keyboard). In this case, adequate clearance between the undersurface of the forward overhanging portions 3g4 and the upper mount portion 3a of the key frame is provided. Such a structure of the first embodiment offers an advantage that placing the upper limit stoppers 11 on the undersurface of the forward overhanging portions 3g4 and fastening the upper limit stoppers 11 to the undersurface of the forward overhanging portions 3g4 are facilitated.

As long as at least the upper part of the respective forward overhanging portions (fixing portions) 3g4 is provided inside the right and left side walls of the respective white key main bodies 1 and the black key main bodies 2, it is considered that the unused inner space between the right and left side walls of each key is efficiently used to accommodate the forward overhanging portions 3g4. As a result, the overlaying of the forward overhanging portions 3g4 with the right and left side walls of the keys contributes reduction in height of the keyboard apparatus.

In the above-described explanation, the plurality of key switches 14 are arranged on the upper surface of the upper mount portion 3a of the key frame 3. Instead of the above-described structure, as described in Japanese Unexamined Patent Publication No. H9-198037 mentioned above, a protruding portion (actuator) may be provided on the lower end surface of each of the massive bodies 8, for example, on the lower end surface between the main driven portion 8a and the pivot fulcrum 8c so as to place. And, a circuit board on which the key switch 14 is placed below the protruding portion.

The above-described supporting portions 3g support not only the white key main bodies 1 and the black key main bodies 2 but also the forward overhanging portions 3g4 which serve as fixing portions to which the upper limit stoppers 11 are fixed. Instead of this structure, supporting portions for supporting the white key main bodies 1 and the black key main bodies 2 and supporting portions for supporting fixing portions of the upper limit stoppers 11 may be provided separately. In a case where such separate supporting portions are employed, the supporting members of the white key main bodies 1 and the black key main bodies 2 can be replaced with different members which are not formed of the shown key fulcrum (penetrating hole) and axes.

In a case where the key frame 3 is made of synthetic resin, the plurality of supporting portions 3g provided for the respective keys can be formed in one piece as part of the key frame 3. However, the supporting portions 3g may be formed separately from the key frame 3 so that the supporting portions 3g are provided on the key frame 3 at the time of assembly. The upper limit stoppers 11 may be formed integrally with the supporting portions 3g by two-color molding. Alternatively, the upper limit stoppers 11 may be bonded to the undersurface of the forward overhanging portions 3g4, respectively.

The stopper members including the above-described upper limit stoppers 11 are required to have restoring force in view of impact absorbability, noise deadening, and reproducibility of stop position of the white key main bodies 1 and the black key main bodies 2, and reproducibility of stop position of the massive bodies 8. More specifically, the stopper members employ an action restricting member such as felt or polyurethane elastomer. In the massive body 8, members from the main driven portion 8a and the secondary driven portion 8b to the pivot fulcrum 8c are formed of synthetic resin or the like in one piece to serve as a base of the massive body 8. The base is formed in one piece by outsert molding in a state where the metal connecting portion 8d is inserted into a die, for example. The mass concentrated portion 8e is made of metal, being formed integrally with the connecting portion 8d, for example.

### b. Second Embodiment

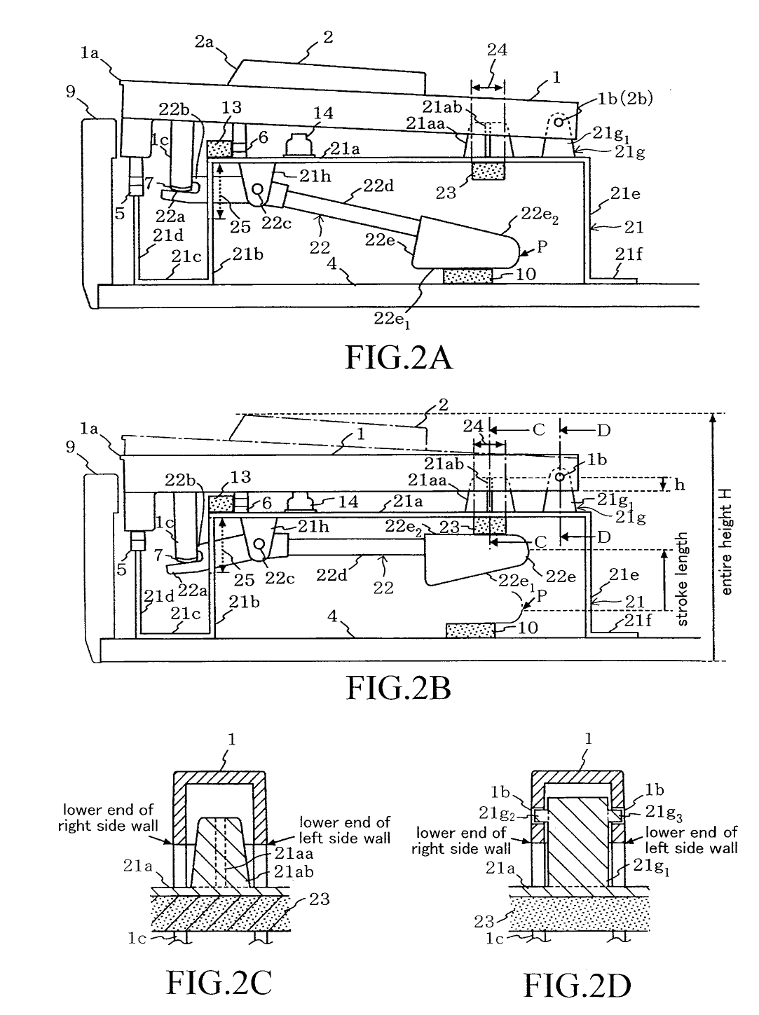

FIG. 2A and FIG. 2B are right side views schematically showing a keyboard apparatus of an electronic musical instrument, the keyboard apparatus being a second embodiment of the present invention. FIG. 2A shows a key-release state in which a key has not been depressed. FIG. 2B shows a state in which the white key main body 1 has been depressed. FIG. 2C is a vertical section view schematically showing the white key main body 1, a key frame 21 and an upper limit stopper 23 when viewed along an arrow C-C in FIG. 2B. FIG. 2D is a vertical section view schematically showing the white key main body 1 and the key frame 21 when viewed along an arrow D-D in FIG. 2B. In these figures, parts similar to those shown in FIGS. 1A to 1C are given the same numbers to omit detailed explanations.

A general structure of the key frame 21 is similar to that of the key frame 3 shown in FIGS. 1A to 1C. The key frame 21 has an upper mount portion 21a, a step portion 21b, a base portion 21c, a vertical wall 21d, a step portion 21e and a base 21f.

In the vicinity of the rear end of the upper mount portion 21a, a plurality of supporting portions 21g are erected. The plurality of supporting portions 21g support their corresponding white key main bodies 1 and black key main bodies 2 in a freely swingable manner. As shown in FIG. 2D, an erected portion 21g1 of each supporting portion 21g protrudes from the upper surface of the upper mount portion 21a. From upper part of the right and left side surfaces of the erected portion 21g1, an axis portions 21g2, 21g3 protrude in the direction in which the keys are arranged. Into the axis portions 21g2, 21g3, the key fulcrum (penetrating hole) 1b or the key fulcrum (penetrating hole) 2b provided on the right and left side walls of the rear end of the white key main body 1 or the black key main body 2 is fitted. The upper part of the respective supporting portions 21g is placed between the right and left vertical side walls of the respective white key main bodies 1. The supporting portions 21g are formed integrally with the key frame 21. Alternatively, the supporting portions 21g may be formed separately from the key frame 21.

Massive bodies 22 are arranged below (including space inside the respective keys) the plurality of white key main bodies 1 and the plurality of black key main bodies 2 (keyboard surface) to correspond to the respective white key main bodies 1 and the respective black key main bodies 2. A general structure of the massive bodies 22 is almost the same as that of the massive bodies 8 shown in FIG. 1A and FIG. 1B. Each of the massive bodies 22 is supported by a massive body supporting portion 21h to pivot through a force conveying portion 1c of a corresponding key. Each of the massive bodies 22 has a main driven portion 22a, a secondary driven portion 22b, a pivot fulcrum 22c, a connecting portion 22d and a mass concentrated portion 22e serving as a free end. The rear end of the connecting portion 22d is connected to the upper part of the front end of the mass concentrated portion 22e. On the step portion 21b of the key frame 21, a plurality of penetrating holes 25 which are shaped like slits are provided to correspond to the plurality of keys, respectively. The respective massive bodies 22 penetrate the respective penetrating holes 25. On the undersurface of the upper mount portion 21a, an upper limit stopper 23 is provided, being fastened to the undersurface in front of the supporting portions 21g. The upper limit stopper 23 is formed like a ribbon whose longitudinal direction coincides with the direction in which the plurality of keys are arranged. The upper limit stopper 23 is shared by all the keys included in the keyboard or by a plurality of keys included in an octave or in a few octaves.

In an initial state shown in FIG. 2A, a lower end surface 22e1 of the mass concentrated portion 22e is in contact with the lower limit stopper (lower limit stopper member) 10. When the key is depressed, the massive body 22 corresponding to the key pivots counterclockwise in spite of gravity. As shown in FIG. 2B, the connecting portion 22d of the massive body 22 becomes horizontal, so that an upper end surface 22e2 of the mass concentrated portion 22e collides with the upper limit stopper (upper limit stopper member) 23. The free end P travels a distance shown as “stroke length”. The black key main body 2 also has a force conveying portion, also being provided with a similar massive body pivotably supported by a massive body supporting portion. Therefore, the massive body of the black key main body 2 pivots through the force conveying portion of the corresponding black key.

When the mass concentrated portion 22e collides with the upper limit stopper 23, the player will recognize a feeling of stop with his finger through the key. However, if an upper limit stopper fixing portion (fixing portion) 24 being situated on an upper mount portion 21a and having the undersurface to which the upper limit stopper 23 is fixed is deformed (distorted), the feeling of stop deteriorates. In a case where the key frame 21 is made of synthetic resin, in particular, the upper limit stopper fixing portion 24 is prone to deformation. By forming vertical ribs 21aa, 21ab on the upper surface of the upper limit stopper fixing portion 24 on the upper mount portion 21a, therefore, the upper limit stopper fixing portion 24 strengthens and improves stiffness.

The shown vertical rib 21aa is a thin plate formed at a position corresponding to the midpoint of the right and left side walls (midpoint in the direction in which the keys are arranged) of the white key main body 1 and the black key main body 2 and extending in the longitudinal direction of the key. The vertical rib 21ab is a thin plate extending from the midpoint of the vertical rib 21aa laterally in the direction in which the keys are arranged. The vertical rib 21aa and the vertical rib 21ab form the vertical ribs shaped like a cross. Only either of the ribs may be provided. Particularly, only the vertical rib 21aa which improves stiffness in the longitudinal direction of the key which is prone to deformation (distortion) may be provided. The above-described upper limit stopper fixing portion 24 is a structure in which the vertical ribs 21aa, 21ab are added to the upper mount portion 21a. Consequently, the upper limit stopper fixing portions 24 are provided to correspond to the respective keys (the respective massive bodies). More specifically, the upper part of the respective upper limit stopper fixing portions 24, in other words, the upper part of the respective vertical ribs 21aa, 21ab is situated inside the right and left side walls of the respective white key main bodies 1 and the respective black key main bodies 2.

In a case where the vertical ribs 21aa, 21ab are placed at any given position on the upper mount portion 21a, the distance from the upper mount portion 21a to the lower end of the right and left side walls of the white key main body 1 and the black key main body 2 has to be sufficient in order to prevent the vertical ribs 21aa, 21ab from interfering with the right and left side walls of the white key main body 1 and the black key main body 2. In the second embodiment, however, the vertical ribs 21aa, 21ab are provided by making full use of free space which is situated inside the right and left side walls of the white key main body 1 or the black key main body 2. Therefore, overlaying of the vertical ribs 21aa, 21ab with the right and left side walls of the white key main body 1 or the black key main body 2 (distance h) contributes reduction in the distance from the upper mount portion 21a to the lower end of the right and left side walls. As a result, the entire height H of the keyboard apparatus can be reduced in comparison with the case where the vertical ribs 21aa, 21ab are placed simply in any given position. In the shown example, although the upper limit stopper 23 is fixed to the undersurface of the upper mount portion 21a in a manner similar to the conventional art, the height of the upper mount portion 21a is designed to have the reduced height of the upper mount portion 3a of the first embodiment shown in FIGS. 1A to 1C. As a result, this embodiment has a stroke length shorter than that of the first embodiment.

### c. Third Embodiment

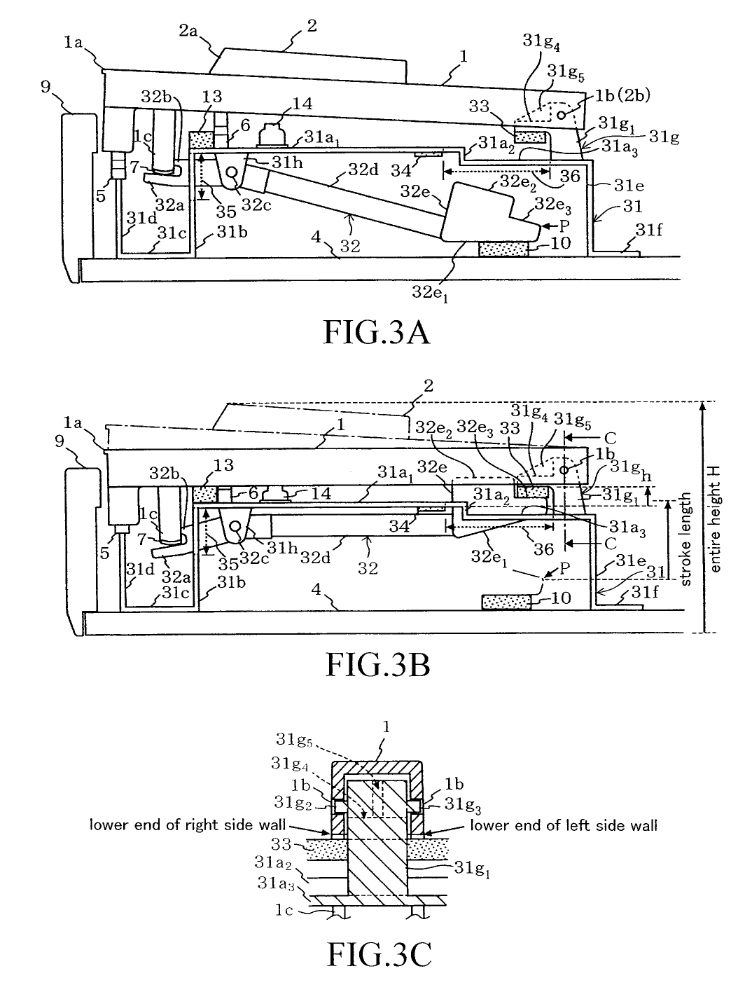

FIG. 3A and FIG. 3B are right side views schematically showing a keyboard apparatus of an electronic musical instrument, the keyboard apparatus being a third embodiment of the present invention. FIG. 3A shows a key-release state in which a key has not been depressed. FIG. 3B shows a state in which the white key main body 1 has been depressed. FIG. 3C is a vertical section view schematically showing the white key main body 1 and a key frame 31 when viewed along an arrow C-C in FIG. 3B. In these figures, parts similar to those shown in FIGS. 1A to 1C are given the same numbers to omit detailed explanations.

A general structure of the key frame 31 is similar to that of the key frame 3 shown in FIGS. 1A to 1C. However, an upper mount portion 31a included in the key frame 31 is separated into the front and the rear. A front upper mount portion 31a1 is connected to a rear upper mount portion 31a3 which is slightly lower than the front upper mount portion 31a1 with a step portion 31a2 interposed in between. The key frame 31 has a step portion 31b, a base 31c, a vertical wall 31d, a step portion 31e and a base 31f. On the step portion 31b, a plurality of penetrating holes 35 shaped like slits are arranged in parallel to correspond to the plurality of keys.

In the vicinity of the rear end of the rear upper mount portion 31a3, a plurality of supporting portions 31g are erected upward to correspond to the plurality of white key main bodies 1 and black key main bodies 2. In the shown example, on the rear part of the front upper mount portion 31a1 of the key frame 31, a plurality of penetrating holes 36 shaped like slits are provided to correspond to the respective keys. Each of the penetrating holes 36 extends from the rear end of a later-described auxiliary stopper 34 to the front of the supporting portion 31g provided on the rear upper mount portion 31a3. Each of erected portions 31g1 has a vertical rib 31g5 provided between an upper portion on which axis portions 31g2, 31g3 are provided and a forward overhanging portion 31g4. The vertical rib 31g5, which is a thin plate whose longitudinal section is shaped like a triangle, is formed at the midpoint of the erected portion 31g1 and the forward overhanging portion 31g4 to correspond to the midpoint of the right and left side walls of the white key main body 1 and the black key main body 2 in the direction in which the keys are arranged. The height of the shown axis portions 31g2, 31g3 is the same as that of the axis portions 3g2, 3g3 shown in FIGS. 1A to 1C.

Because the vertical rib 31g5 strengthens the forward overhanging portion 31g4 (fixing portion), the stiffness of the forward overhanging portion 31g4 is improved to prevent deformation (distortion) of the forward overhanging portion 31g4. As a result, the feeling of stop brought about by an upper limit stopper 33 fixed to the undersurface of the forward overhanging portion 31g4 is improved. In the shown example, the upper portion of the forward overhanging portion 31g4 is situated inside the right and left side walls of the white key main body 1. However, the supporting portion 31g is formed such that the undersurface of the forward overhanging portion 31g4 is situated below the lower end of the right and left side walls of the white key main body 1 and the black key main body 2.

In order to place the upper limit stopper 33 on the undersurface of the forward overhanging portion 31g4 and fix the upper limit stopper 33 to the undersurface of the forward overhanging portion 31g4, there has to be a sufficient clearance which is larger than the thickness of the upper limit stopper 33 between the undersurface of the forward overhanging portion 31g4 and the upper mount portion of the key frame 31. As shown in the figures, therefore, the upper mount portion 31a is divided into the front and the rear so that the height of the rear upper mount portion 31a3 is lower than that of the front upper mount portion 31a1. In the first embodiment as well shown in FIGS. 1A to 1C, the upper mount portion 3a may be divided into the front and the rear so that the height of the rear mount portion is lower than that of the front upper mount portion.

The stroke length of the massive body and the entire height H of the keyboard apparatus of the third embodiment are designed to have those of the first embodiment shown in FIGS. 1A to 1C. However, because the supporting portion 31g has the vertical rib 31g5, the position of the undersurface of the forward overhanging portion (fixing portion) 31g4 cannot be raised as high as the position of the undersurface of the forward overhanging portion (fixing portion) 3g4 shown in FIGS. 1A to 1C. By lowering the rear part (a rear upper end surface 32e3) of the upper end surface of the mass concentrated portion 32e, therefore, the position of the surface with which the upper limit stopper 33 comes into contact is lowered.

Furthermore, the third embodiment is designed such that the undersurface of the forward overhanging portion (fixing portion) 31g4 to which the upper limit stopper 33 is fixed is situated below the lower end of the right and left side walls of the white key main body 1 and the black key main body 2. Therefore, the upper limit stopper 33 can be shaped like a ribbon so as to be shared by all the keys of the keyboard or by a plurality of keys included in an octave or a few octaves. In this case, the upper limit stopper 33 is fixed to the undersurface of the respective forward overhanging portions (fixing portion) 31g4 of the plurality of supporting portions 31g arranged in parallel along the keys by bonding or the like so that the upper limit stopper 33 extends over the plurality of the forward overhanging portions (fixing portions) 31g4.

A plurality of massive bodies 32 are arranged below (including space inside the respective keys) the plurality of white key main bodies 1 and the plurality of black key main bodies 2 (keyboard surface) in parallel so that the respective massive bodies 32 correspond to the respective white key main bodies 1 and the respective black key main bodies 2. Each massive body 32 is supported by a massive body supporting portion 31h to pivot through the force conveying portion 1c of the corresponding key. Each massive body 32 has a main driven portion 32a, a secondary driven portion 32b, a pivot fulcrum 32c, a connecting portion 32d and the mass concentrated portion 32e which is a free end. The rear end of the connecting portion 32d is connected to a lower portion of the front end of the mass concentrated portion 32e. The mass concentrated portion 32e has a lower end surface 32e1. A general structure of the massive body 32 is almost the same as that of the massive body 8 shown in FIG. 1A and FIG. 1B. However, the rear of the upper end surface of the mass concentrated portion 32e is notched to have a step so that the upper end surface is divided into a front upper end surface 32e2 and a rear upper end surface 32e3.

When the white key main body 1 is depressed, the massive body 32 corresponding to the key pivots counterclockwise in spite of gravity. As shown in FIG. 3B, the front upper end surface 32e2 and the rear upper end surface 32e3 of the mass concentrated portion 32e pass through the penetrating hole 36, so that the connecting portion 32d, the front upper end surface 32e2 and the rear upper end surface 32e3 become horizontal to collide the rear upper end surface 32e3 of the mass concentrated portion 32e with the upper limit stopper (action restricting member) 33. As a result, the upper limit of the pivoting of the massive body 32 is restricted. In addition, because the massive body 32 is damped, the player recognizes the feeling of stop with his finger through the key. In the shown example, the front upper end surface 32e2 gets into the inside sandwiched between the right and left side walls of the white key main body 1. The free end P of the mass concentrated portion 32e is to travel a distance shown as “stroke length” in FIG. 3B.

The auxiliary stopper 34 placed on the undersurface of the front upper mount portion 31a1 of the key frame 31a is similar to the auxiliary stopper 12 shown in FIG. 1A and FIG. 1B. Each black key main body 2 similarly has a similar massive body pivotably supported by a massive body supporting portion so that the massive body pivots through the force conveying portion of the corresponding black key to collide a similarly shaped mass concentrated portion with the upper limit stopper 33.

In the conventional art, the upper limit stopper 33 is placed on the undersurface of the key frame (equivalent to the front upper mount portion 31a1) to be fixed to the undersurface. In the third embodiment, therefore, members for fixing the upper limit stopper 33 are raised from the undersurface of the key frame 31a to the undersurface of the forward overhanging portions 31g4 by a distance h, so that the position of the front upper mount portion 31a1 and the rear upper mount portion 31a2 is lowered to reduce the entire height H of the keyboard apparatus.

Even if the height of the front upper end surface 32e2 were lowered to have the mass concentrated portion 32e in which the front upper end surface 32e2 has the same level as the shown rear upper end surface 32e3, the entire height H of the keyboard apparatus would be reduced by the distance h. However, the mass concentrated portion 32e is designed such that the front upper end surface 32e2 is higher than the rear upper end surface (the first contact portion) 32e3, resulting in the mass of the mass concentrated portion 32e being increased to increase the inertial moment of the massive body 32. More specifically, the mass concentrated portion 32e of the third embodiment is designed such that the front upper end surface 32e2 is high (long in vertical dimension) enough to get into the inside sandwiched between the right and left side walls of the white key main body 1. Consequently, the free space which is situated inside the right and left side walls of the key is efficiently used to increase the inertial moment of the massive body 32.

### d. Fourth Embodiment

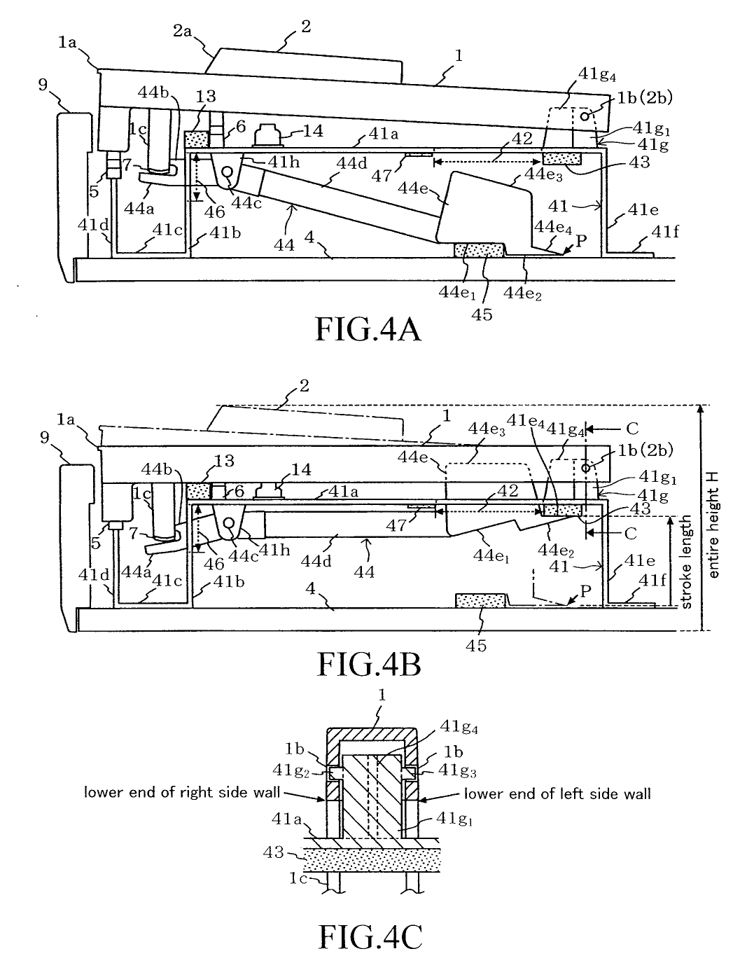

FIG. 4A and FIG. 4B are right side views schematically showing a keyboard apparatus of an electronic musical instrument, the keyboard apparatus being a fourth embodiment of the present invention. FIG. 4A shows a key-release state in which a key has not been depressed. FIG. 4B shows a state in which the white key main body 1 has been depressed. FIG. 4C is a vertical section view schematically showing the white key main body 1 and a key frame 41 when viewed along an arrow C-C in FIG. 4B. In these figures, parts similar to those shown in FIGS. 1A to 1C are given the same numbers to omit detailed explanations.

A general structure of the key frame 41 is similar to that of the key frame 3 shown in FIGS. 1A to 1C. The key frame 41 has an upper mount portion 41a, a step portion 41b, a base portion 41c, a vertical wall 41d, a step portion 41e and a base 41f. On the upper surface in the vicinity of the rear end of the upper mount portion 41a, a plurality of supporting portions 41g are arranged to protrude upward in parallel to correspond to the plurality of white key main bodies 1 and black key main bodies 2. The plurality of supporting portions 41g support their corresponding white key main bodies 1 and the black key main bodies 2 in a freely swingable manner. On the rear part of the upper mount portion 41a, in other words, at the front of the supporting portions 41g, a plurality of penetrating holes 42 shaped like slits are provided to correspond to the respective keys. As shown in FIG. 4C, the supporting portion 41g has an erected portion 41g1 and a vertical rib 41g4. The vertical rib 41g4, which is situated at the midpoint of the key in the direction in which the keys are arranged, is a thin plate extending frontward by a specified distance from the front surface of the erected portion 41g1.

The vertical rib 41g4 is provided on the upper mount portion 41a of the key frame 41. More specifically, the vertical rib 41g4 is situated on the upper surface of a part to which a later-described upper limit stopper (upper limit stopper member) 43 is fixed. Therefore, the stiffness of the part increases. In addition, the erected portion 41g1 and the vertical rib 41g4 are situated in the vicinity of the step portion 41e. As a result, when a mass concentrated portion 44e of a later-described massive body 44 collides with the upper limit stopper 43, the part to which the upper limit stopper 43 is fixed is less deformed (distorted), resulting in the feeling of stop recognized by the player with his finger being improved.

Inside the right and left side walls of the white key main body 1 or the black key main body 2, there is space situated inside the key, the space being open downward. The upper portion of the above-described erected portion 41g1 and the vertical rib 41g4 are provided so as to be overlaid with the right and left side walls of the white key main body 1 or the black key main body 2 without interfering with the right and left side walls of the white key main body 1 or the black key main body 2. Therefore, because the vertical rib 41g4 is overlaid with the right and left side walls of the white key main body 1 or the black key main body 2, the existence of the vertical rib 41g4 will not cause an increase in the entire height H of the apparatus shown in FIG. 4B.

On the upper portion of the right and left side surfaces of the erected portion 41g1, axis portions 41g2, 41g3 are provided. The axis portions 41g2, 41g3 overhang in the direction in which the keys are arranged. Into the axis portions 41g2, 41g3, the key fulcrum 1b (penetrating hole) provided on the right and left side walls of the rear end of the white key main body 1 is fitted. Supporting portions 41g which are not shown and provided for the black key main bodies 2 are configured similarly. Into the axis portions 41g2, 41g3, more specifically, the key fulcrum 2b (penetrating hole) provided on the right and left side walls of the rear end of the black key main body 2 is fitted. Each white key main body 1 or black key main body 2 is supported in a swingable manner in the direction in which the key is depressed and released about the key fulcrum 1b, 2b.

The plurality of massive bodies 44, a lower limit stopper 45 and the upper limit stopper 43 are situated below (including the space situated inside the respective keys) the plurality of white key main bodies 1 and the plurality of black key main bodies 2 (keyboard surface). A general structure of the massive body 44 is almost the same as that of the massive body 8 shown in FIG. 1A and FIG. 1B. The massive body 44 has a pivot fulcrum 44c supported by a massive body supporting portion 41h, a main driven portion 44a and a secondary driven portion 44b which are bifurcated and installed forward of the pivot fulcrum 44c to be engaged with the force conveying portion 1c of the corresponding key through the elastic member 7, and a mass concentrated portion 44e which is situated behind the pivot fulcrum 44c with a connecting portion 44d sandwiched in between and serves as a free end.

The rear end of the connecting portion 44d is connected to the lower portion of the front end of the mass concentrated portion 44e. The width of the mass concentrated portion 44e along the arranged keys is smaller than the inner width between the right and left side walls of each key. On the step portion 41b of the key frame 41, a plurality of penetrating holes 46 shaped like slits are provided so as to correspond to the plurality of keys. The massive body 44 penetrates the penetrating hole 46 between the driven portion 44a, 44b and the pivot fulcrum 44c.

The mass concentrated portion 44e has a front lower end surface 44e1 and a rear lower end surface 44e2. In the key-release state shown in FIG. 4A where the key has been released, the front lower end surface 44e1 is located in a position higher than the rear lower end surface 44e2. The rear lower end surface 44e2 is located close to the key frame bottom board 4 to such an extent as not to come into contact with the key frame bottom board 4. In the shown example, both are kept horizontal. The front lower end surface 44e1 serves as a contact part (second contact part) which comes into contact with the lower limit stopper 45 (lower limit stopper member). The lower limit stopper 45 is fastened to the upper surface of the key frame bottom board 4.

On the mass concentrated portion 44e, there is a front upper end surface 44e3 above the front lower end surface 44e1, while there is a rear upper end surface 44e4 above the rear lower end surface 44e2. In the state shown in FIG. 4B where the key has depressed, the rear upper end surface 44e4 serves as a contact part (first contact part) which comes into contact with a later-described upper limit stopper 43. In the shown example, both of the front upper end surface 44e3 and the rear upper end surface 44e4 are in parallel with the upper mount portion 41a of the key frame 41 to be kept horizontal. In this embodiment, the front lower end surface 44e1 (second contact part) is located in a position higher than the lowest end (equivalent to the free end P in the shown example) of the rear upper end surface 44e4 (first contact part).

In the key-release state shown in FIG. 4A where the key has been released, if the key main body (in the shown example, the white key main body 1) is depressed, the massive body 44 corresponding to the key pivots counterclockwise in spite of gravity. The front upper end surface 44e3 of the mass concentrated portion 44e passes through the penetrating hole 42 and then gets into the inside sandwiched between the right and left side walls of the white key main body 1 without interfering with the right and left side walls of the white key main body 1. During the move of the mass concentrated portion, a counteraction according to the inertial moment of the massive body 44 is conveyed to the white key main body 1, resulting in a feeling of mass being delivered to a finger of the player. As shown in FIG. 4B, the connecting portion 44d of the massive body 44 becomes horizontal to collide the rear upper end surface (the first contact part) 44e4 of the mass concentrated portion 44e with the upper limit stopper (upper limit stopper member) 43, resulting in restriction on the upper limit of the pivoting massive body 44. Because the restriction on the pivoting of the massive body 44 also involves damping of the massive body 44, the player will recognize a feeling of stop with his finger through the key. The free end P is to travel a distance shown in FIG. 4B as “stroke length”. Because the upper limit stopper 43 is fastened to the undersurface of the key frame 41, an impact caused by a collision of the rear upper end surface 44e4 of the mass concentrated portion 44e with the upper limit stopper 43 will not be conveyed to a finger of the player through the key.

In general, it is known that parts of a pivoting member from a contact part to a pivot fulcrum are not prone to deformation while parts from the contact part to a free end are prone to deformation. In the state shown in FIG. 4B where the key has been depressed, therefore, the rear upper end surface (first contact part) 44e4 which comes into contact with the upper limit stopper 43 is positioned in the vicinity of the free end P (“vicinity” can include the free end P and also can exclude the free end P), resulting in a favorable feeling of stop being delivered to the player. In addition, the member of the free end P side can deform, resulting in reduced possibility that the rear upper end surface 44e4 collide with an unexpected part other than the upper limit stopper 43 such as the upper mount portion 41a of the key frame 41 and the white key main body 1.

On the undersurface of the upper mount portion 41a of the key frame 41, an auxiliary stopper 47 is provided so as to adjoin to the front end of the penetrating hole 42 in the shown example. If a depression of the key causes the massive body 44 to transiently exceed (over-stroke) the upper limit position (fully depressed standstill position) of the pivoting of the massive body 44, the auxiliary stopper 47 prevents collision of the connecting portion 44d with the upper mount portion 41a of the key frame 41. In a case where there is no possibility of such collision, however, the auxiliary stopper 47 is not necessary.

If the player releases the key, the massive body 44 pivots in a reverse direction because of its self weight to return to the position shown in FIG. 4A. As a result, the front lower end surface 44e1 of the mass concentrated portion 44e collides with the lower limit stopper 45, resulting in the initial position of the massive body 44 (key-release state) being defined. Because collision of the mass concentrated portion 44e with the lower limit stopper 45 is caused only by gravity without any key-depression force, an impact brought about by the collision is small. Therefore, although the front lower end surface (second contact part) 44e1 which comes into contact with the lower limit stopper 45 has a shorter distance to the pivot fulcrum 44c than the rear upper end surface (first contact part) 44e4, deformation of the massive body 44 will not present any problem. Because the lower end surface 44e1 of the mass concentrated portion 44e in which the mass of the massive body 44 concentrates has the contact part (second contact part) which comes into contact with the lower limit stopper 45, deterioration in the feeling of stop such as rebound and vibration at the time of key-release can be reduced.

When the white key main body 1 or the black key main body 2 is depressed, on the other hand, the lower limit stopper 43 provided on the upper surface of the front part of the upper mount portion 41a of the key frame 41 restricts lower limit of the lower end of the right and left side walls of the depressed key. Because the above-described upper limit stopper 43 is fixed to the upper mount portion 41a of the key frame 41, by arranging the upper limit stopper 43 like a ribbon along the arranged keys like the lower limit stopper 45, the auxiliary stopper 47 and the lower limit stopper 13, the upper limit stopper 43 can be shared by the plurality of massive bodies 44 of at least two corresponding keys. More specifically, the upper limit stopper 43 can be shared by the plurality of massive bodies 44 of all the keys or by the plurality of massive bodies 44 of keys included in an octave or a few octaves. Compared with a case where the upper limit stopper 43 is provided for each massive body 44 to be fixed separately, the fourth embodiment in which the upper limit stopper 43 is shared by the plurality of massive bodies improves the efficiency of assembly of the keyboard apparatus.

In this embodiment, in the key-release state shown in FIG. 4A where the key has been released, the front lower end surface 44e1 (second contact part) is located in a position higher than the lowest end of the rear upper end surface (first contact part) 44e4. As a result, the mass concentrated portion 44e is partly overlaid with the lower limit stopper 45 in the height direction. In the conventional massive body as described in Japanese Unexamined Patent Publication NO. H4-142595, however, a flat lower end surface comes into contact with a lower limit stopper. As a result, the lower end surface (second contact part) is located in a high position according to the thickness of the lower limit stopper, resulting in the entire height of the keyboard apparatus being raised. In this embodiment, however, the height of the upper mount portion 41a of the key frame 41 is lower than that of the conventional art because of the overlaying of the mass concentrated portion 44e with the lower limit stopper 45, resulting in the entire height H of the keyboard apparatus being lowered.

In the state shown in FIG. 4B where the key has been depressed, furthermore, the front upper end surface 44e3 is located in a position higher than the rear upper end surface (first contact part) 44e4. This structure contributes increase in the mass of the mass concentrated portion 44e. The mass concentrated portion 44e is designed such that the upper part (the front upper end surface 44e3) of the mass concentrated portion 44e is located in the unused space which is located inside the right and left side walls of the key when the key has been depressed. More specifically, the massive body 44 is overlaid with the key in the height direction without interfering with the right and left side walls of the key, resulting in the entire height H of the keyboard apparatus being unchanged. The mass concentrated portion 44e may be designed such that the front upper end surface 44e3 is overlaid with only the upper limit stopper 43 in a state where the key has been fully depressed. Alternatively, the mass concentrated portion 44e may be designed such that the front upper end surface 44e3 is located between the upper surface of the upper mount portion 41a and the lower end of the right and left side walls of the key in the state where the key has been fully depressed.

### e. Fifth Embodiment

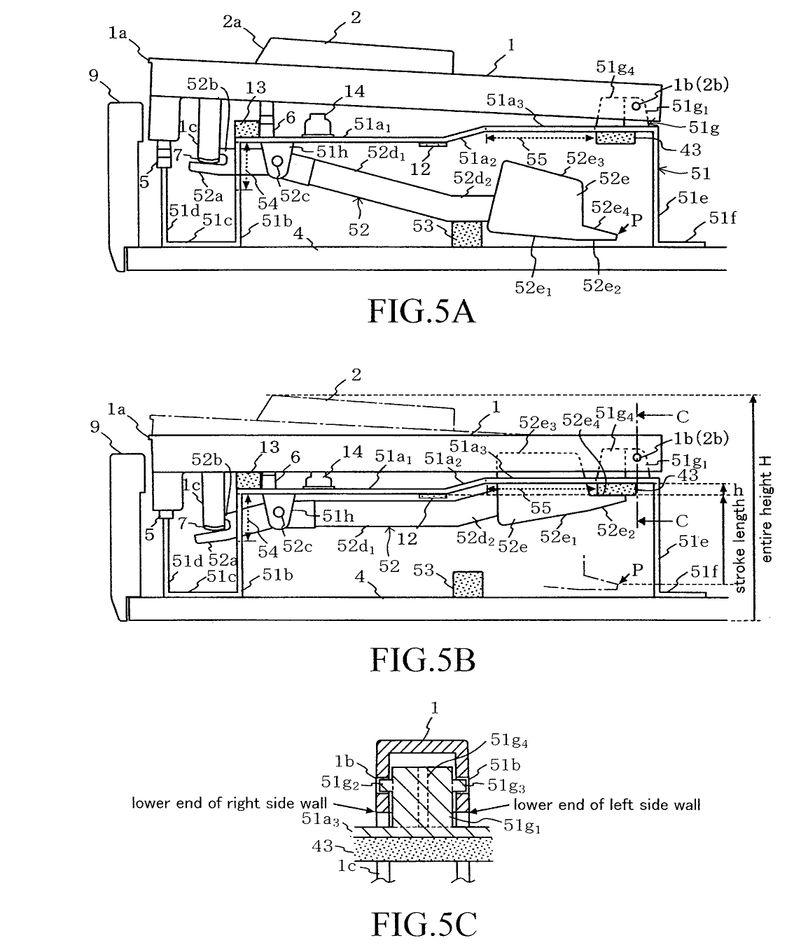

FIG. 5A and FIG. 5B are right side views schematically showing a keyboard apparatus of an electronic musical instrument, the keyboard apparatus being a fifth embodiment of the present invention. FIG. 5A shows a key-release state in which a key has not been depressed. FIG. 5B shows a state in which the white key main body 1 has been fully depressed. FIG. 5C is a vertical section view schematically showing the white key main body 1, a key frame 51 and an upper limit stopper 53 when viewed along an arrow C-C in FIG. 5B. In these figures, parts similar to those shown in FIGS. 4A to 4C are given the same numbers to omit detailed explanations. In comparison to the embodiment shown in FIGS. 4A to 4C, the fifth embodiment is designed such that a part which comes into contact with the lower limit stopper is provided on the undersurface of a connecting portion while the position of the upper limit stopper is raised by raising the rear part of the upper mount portion of the key frame.

A general structure of the key frame 51 is similar to that of the key frame 41 shown in FIG. 4A and FIG. 4B. However, an upper mount portion 51a included in the key frame 51 is separated into the front and the rear. A front upper mount portion 51a1 is connected to a rear upper mount portion 51a3 which is slightly higher than the front upper mount portion 51a1 with a transition portion 51a2 interposed in between. The key frame 51 has a step portion 51b, a base 51c, a vertical wall 51d, a step portion 51e and a base 51f. On the step portion 51b, a plurality of penetrating holes 54 shaped like slits are arranged to correspond to the plurality of keys. In the vicinity of the rear end of the rear upper mount portion 51a3, a plurality of supporting portions 51g are arranged in parallel to correspond to the plurality of white key main bodies 1 and black key main bodies 2. Each supporting portion 51g has an erected portion 51g1 and a vertical rib 51g4. On the rear part of the rear upper mount portion 51a3, a plurality of penetrating holes 55 shaped like slits are provided in front of the supporting portions 51g to correspond to the respective keys.

As shown in FIG. 5C, on the upper part of the right and left side surfaces of the erected portion 51g1, axis portions 51g2, 51g3 are provided. The height of the shown axis portions 51g2, 51g3 is the same as that of the axis portions 41g2, 41g3 shown in FIG. 4C. The upper part of the supporting portion 51g is located inside the right and left side walls of the white key main body 1 or the black key main body 2. Massive bodies 52 are arranged below (including the space situated inside the respective keys) the plurality of white key main bodies 1 and the plurality of black key main bodies 2 (keyboard surface) so as to correspond to the keys, respectively. A general structure of the massive body 52 is almost the same as that of the massive body 44 shown in FIGS. 4A to 4C. The massive body 52 is supported by a massive body supporting portion 51h to pivot through the force conveying portion 1c of the corresponding key.

The massive body 52 has a main driven portion 52a, a secondary driven portion 52b and a pivot fulcrum 52c. A connecting portion 52d has a structure in which a front connecting portion 52d1 is connected to a rear connecting portion 52d2. When the key has been released as shown in FIG. 5A, the rear connecting portion 52d2 comes into contact with the lower limit stopper 53. At the time of contact, in the shown example, the lower end surface (second contact part) of the rear connecting portion 52d2 becomes horizontal to be parallel to the key frame bottom board 4. The rear end of the rear connecting portion 52d2 is connected to the lower part of the front end of a mass concentrated portion 52e.

The mass concentrated portion 52e has a front lower end surface 52e1 and a rear lower end surface 52e2. In the key-release state shown in FIG. 5A, in the shown example, the front lower end surface 52e1, which is an inclined surface where the rear is lowered, is connected to the rear lower end surface 52e2 which is horizontal. In this key-release state, the lower end surface (second contact part) of the rear connecting portion 52d2 is located in a position higher than the lowest end of a later-described rear upper end surface 52e4 (first contact part). The rear lower end surface 52e2 is located close to the key frame bottom board 4 to such an extent as not to come into contact with the key frame bottom board 4. The rear connecting portion (second contact part) 52d2 serves as a contact part which comes into contact with the lower limit stopper 53. The lower limit stopper 53 is fastened to the upper surface of the key frame bottom board 4.

The mass concentrated portion 52e has a front upper end surface 52e3 situated above the front lower end surface 52e1. The mass concentrated portion 52e also has a rear upper end surface (first contact part) 52e4 situated above the rear lower end surface 52e2. In the shown example, the front upper end surface 52e3 and the rear upper end surface 52e4 become parallel with the rear upper mount portion 51a3 of the key frame 51 to be horizontal in the state shown in FIG. 5B where the key has been depressed. The rear upper end surface 52e4 serves as a contact part (first contact part) which comes into contact with the upper limit stopper 43.

In the key-release state shown in FIG. 5A, if the white key main body 1 is depressed, the massive body 52 provided for the key pivots counterclockwise in spite of gravity. Because this embodiment is designed such that the rear upper end surface 52e4 is lowered, the position of the front upper end surface 52e3 is higher than the upper limit stopper 43 when the key has been fully depressed as shown in FIG. 5B. In the shown example, the massive body 52 pivots so that the front upper end surface 52e3 passes through the penetrating hole 55 with the front connecting portion 52d1 becoming horizontal and that the front upper end surface 52e3 gets into the inside sandwiched between the right and left side walls of the white key main body 1, with the rear upper end surface 52e4 colliding with the upper limit stopper (action restricting member) 43. The free end P travels a distance shown in FIG. 5B as “stroke length”. Each black key main body 2 also has a similar massive body which pivots by a force conveying portion of the corresponding key to collide with the upper limit stopper 43.

In the shown example, the entire height H of the keyboard apparatus is the same as that of the embodiment shown in FIG. 4A to FIG. 4C. However, because the rear upper mount portion 51a3 is higher than the front upper mount portion 51a1 (by a distance h), the position of the upper limit stopper 43 displaces upward by the distance h. As a result, it is possible to make the height of the rear upper end surface 52e4 in the key-release state shown in FIG. 5A higher than that of the rear upper end surface 44e4 shown in FIGS. 4A to 4C. Consequently, the vertical thickness (in the height direction) between the rear lower end surface 52e2 and the rear upper end surface 52e4 can be increased, which results in increase in strength of the parts. Alternatively, in a case where the vertical thickness between the rear lower end surface 52e2 and the rear upper end surface 52e4 is made as thin as that shown in FIGS. 4A to 4C, the entire height H of the keyboard apparatus can be made lower than that of the embodiment shown in FIG. 1.

### f. Sixth Embodiment

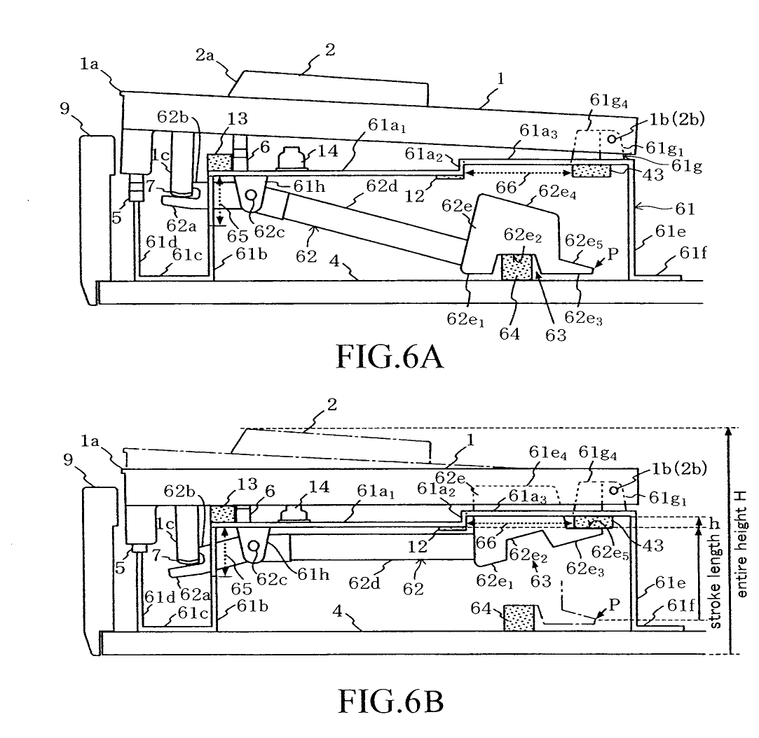

FIG. 6A and FIG. 6B are right side views schematically showing a keyboard apparatus of an electronic musical instrument, the keyboard apparatus being a sixth embodiment of the present invention. FIG. 6A shows a key-release state in which a key has not been depressed. FIG. 6B shows a state in which the white key main body has been depressed. The vertical section view of the white key main body 1 and a key frame 61 is omitted, for the vertical section view would be the same as that of the white key main body 1 and the key frame 51 shown in FIG. 5C. In these figures, parts similar to those shown in FIGS. 4A to 4C are given the same numbers to omit detailed explanations.

This embodiment is designed such that a mass concentrated portion 62 has a part which comes into contact with a lower limit stopper 64. A general structure of the key frame 61 is similar to that of the key frames 41, 51 shown in FIGS. 4A to 4C, and 5A to 5C. A front upper mount portion 61a1 is connected to a rear upper mount portion 61a3 which is higher than the front upper mount portion 61a1 through a step portion 61a2. The step is designed to correspond with the shape of connection between a later-described connecting portion 62d and mass concentrated portion 62e of a massive body.

The key frame 61 has a step portion 61b, a base 61c, a vertical wall 61d, a step portion 61e and a base 61f. On the step portion 61b of the key frame 61, a plurality of penetrating holes 65 shaped like slits are arranged to correspond to the plurality of keys. In the vicinity of the rear end of the rear upper mount portion 61a3, a plurality of supporting portions 61g are arranged in parallel to correspond to the plurality of keys. Each supporting portion 61g has an erected portion 61g1 and a vertical rib 61g4. On the rear upper mount portion 61a3 of the key frame 61, a plurality of penetrating holes 66 shaped like slits are provided to correspond to the respective keys.

Massive bodies 62 are arranged below (including space inside the respective keys) the plurality of white key main bodies 1 and the plurality of black key main bodies 2 (keyboard surface) to correspond to the respective white key main bodies 1 and the black key main bodies 2. A general structure of the massive bodies 62 is almost the same as that of the massive bodies 44, 52 shown in FIGS. 4A to 4C and FIGS. 5A to 5C. Each massive body 62 is supported by a massive body supporting portion 61h to pivot through the force conveying portion 1c of a corresponding key. Each massive body 62 has a main driven portion 62a, a secondary driven portion 62b, a pivot fulcrum 62c, a connecting portion 62d and a mass concentrated portion 62e. The rear end of the connecting portion 62d is perpendicularly connected to the lower part of the front end of the mass concentrated portion 62e. The mass concentrated portion 62e has a concave portion 63 provided between a front lower end surface 62e1 and a rear lower end surface 62e3. The concave portion 63 is open downward. In the shown example, both the front lower end surface 62e1 and the rear lower end surface 62e3 are away from the key frame bottom board 4 by the same distance, being in a horizontal position. In the key-release state, the upper part of a lower limit stopper 64 is situated inside the concave portion 63 to be in contact with a ceiling surface (second contact part) 62e2 of the concave portion 63. Because the concave portion 63 is overlaid with the massive body 62 (mass concentrated portion 62e) when viewed in the height direction, the entire height H of the keyboard apparatus will not be raised.

Similarly to the mass concentrated portion 44e shown in FIG. 4A to FIG. 4C, because the mass concentrated portion 62e in which the mass of the massive body 62 concentrates has a contact part (the second contact part, that is, the ceiling surface 62e2 of the concave portion 63) which comes into contact with the lower limit stopper 64, deterioration in the feeling of stop such as rebound and vibration at the time of key-release can be reduced. In the case of the mass concentrated portion 44e shown in FIGS. 4A to 4C, however, there is a clearance on the left side (frontward in the longitudinal direction of a key) of the lower limit stopper 45, the clearance being positioned between the lower end surface 44e1 and the key frame bottom board 4. In the case of the mass concentrated portion 62e, the first lower end surface 62e1 is placed close to the bottom board 4 of the key frame to fill in the clearance. As a result, it is possible to increase the mass of the mass concentrated portion 62e, also increasing the inertial moment of the massive body 62.

The mass concentrated portion 62e has a front upper end surface 62e4 which is situated above a part extending from the front lower end surface 62e1 to the front part of the rear lower end surface 62e3 through the ceiling surface 62e2 (second contact part). The mass concentrated portion 62e also has a rear upper end surface 62e5 which is situated above a rear part of the rear lower end surface 62e3. In this embodiment, in the key-release state shown in FIG. 6A, the ceiling surface (second contact part) 62e2 is located in a position higher than the lowest end of the rear upper end surface (first contact part) 62e5. In the shown example, the front upper end surface 62e4 and the rear upper end surface 62e5 become horizontal to be in parallel with the rear upper mount portion 61a3 of the key frame in a state shown in FIG. 6B where the key has been depressed. The rear upper end surface 62e5 serves as a contact part (first contact part) which comes into contact with the upper limit stopper 61.

In the key-release state shown in FIG. 6A, when the white key main body 1 is depressed, the massive body 62 corresponding to the key pivots counterclockwise in spite of gravity. In the shown example, the massive body 62 pivots so that the front upper end surface 62e4 passes through the penetrating hole 66 with the connecting portion 62d becoming horizontal and that the front upper end surface 62e4 gets into the inside sandwiched between the right and left side walls of the white key main body 1, with the rear upper end surface 62e5 colliding with the upper limit stopper (action restricting member) 43. The free end P travels a distance shown in FIG. 6B as “stroke length”. Each black key main body 2 also has a similar massive body which pivots by a force conveying portion of the corresponding key to collide with the upper limit stopper 43.

In the shown example, the height of the front upper mount portion 61a1 and the entire height H of the keyboard apparatus are the same as those of the embodiment shown in FIGS. 4A to 4C. Similarly to the embodiment shown in FIGS. 5A to 5C, however, the position of the upper limit stopper 43 displaces upward by the distance h. As a result, the vertical thickness (in the height direction) between the rear lower end surface 62e3 and the rear upper end surface 62e5 can be increased. Alternatively, in a case where the vertical thickness between the rear lower end surface 62e3 and the rear upper end surface 62e5 is made as thin as that shown in FIGS. 4A to 4C, the entire height H of the keyboard apparatus can be made lower than that of the embodiment shown in FIGS. 4A to 4C.

### g. Other Modified Examples

In the above-described respective embodiments, the plurality of massive bodies 8, 22, 32, 44, 52, 62, the lower limit stoppers 10, 45, 53, 64 and the upper limit stoppers 11, 23, 33, 43 are placed below (including the space inside the respective keys) the plurality of white key main bodies 1 and the plurality of black key main bodies 2 (keyboard surface). More specifically, being placed below the white key main bodies 1 and the black key main bodies 2 indicates that, when viewed in the height direction of the apparatus, the height of the respective positions where the plurality of massive bodies, the lower limit stoppers and the upper limit stoppers are placed are lower than the height of the plurality of white key main bodies 1 and the plurality of black key main bodies 2 (keyboard surface). In the respective embodiments, the plurality of massive bodies, the lower limit stoppers and the upper limit stoppers completely fit, in the longitudinal direction of the respective keys, into a section ranging from the tip 1a of the respective white key main bodies to the rear end of the respective white key main bodies 1 and the respective black key main bodies 2. However, at least any one item of the plurality of massive bodies, the lower limit stoppers and the upper limit stoppers may extend off the section. For instance, at least one item may protrude backward from the rear end of the respective white key main bodies 1 and the respective black key main bodies 2. As long as the protrusion is slight, the protrusion will have little effect on the depth of the electronic keyboard instrument equipped with other components in addition to the keyboard apparatus.

In the above-described respective embodiments, the massive bodies 8, 22, 32, 44, 52, 62 are designed to have the mass concentrated portions 8e, 22e, 32e, 44e, 52e, 62e situated on their free end side. However, as long as the respective massive bodies pivot in synchronization with key-depression of the respective keys, the respective embodiments may be modified to have a structure in which it is not clear that the mass is concentrated.

In the above-described respective embodiments, the massive body supporting portions 3h, 21h, 31h, 41h, 51h, 61h are erected on the undersurface of the upper mount portion 3a, 21a, 31a1 (front upper mount portion), 41a, 51a1 (front upper mount portion), 61a1 (front upper mount portion) of the respective key frames 3, 21, 31, 41, 51. However, the respective massive body supporting portions may be erected on the upper surface of the key frame bottom board 4. Alternatively, the key frames 3, 21, 31, 41, 51, 61 may have a front lower mount portion so that the massive body supporting portions are erected on the upper surface of the front lower mount portion. In these cases, the frames are designed such that any part of the key frames 3, 21, 31, 41, 51, 61 is not located on an area where the driven side of the massive bodies 8, 22, 32, 44, 52, 62 passes through (equivalent to the area of the penetrating holes 15, 25, 35, 46, 54, 65) and on an area where the mass concentrated portion 8e, 22e,32e, 44e, 52e, 62e passes through (equivalent to the area of the penetrating holes 16, 36, 42, 55, 66) during pivoting of the massive bodies 8, 22, 32, 44, 52, 62.

What is claimed is:

1. A keyboard apparatus of an electronic musical instrument, the keyboard apparatus comprising:
a plurality of keys;
a plurality of massive bodies situated below the plurality of keys in a one-to-one correspondence with the keys, each massive body pivoting in synchronization with key-depression of its corresponding key;
a frame on which the plurality of keys and the plurality of massive bodies are arranged in parallel;
an upper limit stopper member which is placed below the plurality of keys to be fixed to the frame side such that a collision of each massive body with the upper limit stopper member results in restriction on upper limit of pivoting range of the each massive body;
a lower limit stopper member which is placed below the plurality of keys to be fixed to the frame side such that a collision of each massive body with the lower limit stopper member results in restriction on lower limit of pivoting range of the each massive body; and
a plurality of fixing portions provided on the frame in a one-to-one correspondence with the plurality of keys, at least an upper part of each fixing portion being situated inside right and left side walls of its corresponding key, each fixing portion having an undersurface to which the upper limit stopper member is fixed.

2. A keyboard apparatus of an electronic musical instrument according to claim 1, wherein
the plurality of fixing portions protrude upward from an upper surface of the frame;
the frame has a plurality of penetrating holes through which the plurality of massive bodies pass; and
the each massive body is situated below the frame in a state where a key corresponding to the each massive body has been released, while the each massive body is displaced upward to be situated above the frame through the penetrating hole corresponding to the each massive body when the key corresponding to the each massive body is depressed.

3. A keyboard apparatus of an electronic musical instrument according to claim 2, wherein
each of the plurality of fixing portions is formed of an erected portion being erected upward from the upper surface of the frame and a forward overhanging portion overhanging forward from an upper portion of the erected portion; and
the upper limit stopper member is fixed to an undersurface of the forward overhanging portion of each fixing portion.

4. A keyboard apparatus of an electronic musical instrument according to claim 3, wherein
the undersurface of the forward overhanging portion is situated below lower end surface of right and left side walls of its corresponding key even in a state where the corresponding key has been depressed.

5. A keyboard apparatus of an electronic musical instrument according to claim 4, wherein
the upper limit stopper member is shaped like a ribbon whose longitudinal direction coincides with a direction in which the plurality of keys are arranged, and continuously extends over at least two neighboring keys to be fixed to the undersurface of the respective forward overhanging portions provided for the at least two keys.

6. A keyboard apparatus of an electronic musical instrument according to claim 3, wherein
a vertical rib is provided on an upper surface of the forward overhanging portion.

7. A keyboard apparatus of an electronic musical instrument according to claim 2, wherein
the frame has a step which extends in the direction in which the plurality of keys are arranged and is situated midway between a front and a rear of the frame so that the height of the rear is lower than that of the front; and
the plurality of fixing portions are provided on an upper surface of the rear.

8. A keyboard apparatus of an electronic musical instrument according to claim 2, wherein
the each massive body has a mass concentrated portion situated at a rear end of the each massive body; and
the mass concentrated portion has a step situated on an upper surface of the mass concentrated portion so that a vertical thickness of a part which comes into contact with the upper limit stopper member at the time of key-depression of the corresponding key is smaller than that of other parts of the mass concentrated portion.

9. A keyboard apparatus of an electronic musical instrument according to claim 2, wherein
the plurality of fixing portions pivotably support the plurality of keys, respectively.

10. A keyboard apparatus of an electronic musical instrument according to claim 1, wherein
each of the plurality of fixing portions has a vertical rib situated on an upper surface side of the each fixing portion.

11. A keyboard apparatus of an electronic musical instrument according to claim 1, wherein
the undersurface of the each fixing portion is situated below lower end surface of right and left side walls of its corresponding key even in a state where the corresponding key has been depressed.

12. A keyboard apparatus of an electronic musical instrument according to claim 11, wherein
the upper limit stopper member is shaped like a ribbon whose longitudinal direction coincides with a direction in which the plurality of keys are arranged, and continuously extends over at least two neighboring keys to be fixed to the undersurface of the respective fixing portions provided for the at least two keys.

13. A keyboard apparatus of an electronic musical instrument according to claim 1, wherein
the plurality of fixing portions are part of the frame;
the upper limit stopper member is fixed to the undersurface of the respective fixing portions; and
the each massive body is situated below the frame even in a state where a key corresponding to the each massive body has been depressed.

14. A keyboard apparatus of an electronic musical instrument, the keyboard apparatus comprising:
a plurality of keys;
a plurality of massive bodies situated below the plurality of keys in a one-to-one correspondence with the keys, each massive body pivoting in synchronization with key-depression of its corresponding key;
a frame on which the plurality of keys and the plurality of massive bodies are arranged in parallel;
an upper limit stopper member which is placed below the plurality of keys to be fixed to the frame side such that a collision of each massive body with the upper limit stopper member results in restriction on upper limit of pivoting range of the each massive body; and
a lower limit stopper member which is placed below the plurality of keys to be fixed to the frame side such that a collision of each massive body with the lower limit stopper member results in restriction on lower limit of pivoting range of the each massive body;
the each massive body having a first contact portion which comes into contact with the upper limit stopper member in a state where a key corresponding to the each massive body has been depressed and a second contact portion which comes into contact with the lower limit stopper member in a state where the corresponding key has been released; and
the first contact portion being situated close to a free end of the each massive body with the second contact portion being situated closer to a pivot fulcrum side of the each massive body than the first contact portion, the second contact portion being situated in a position higher than the lowest end of the first contact portion in a state where the key corresponding to the each massive body has been released.

15. A keyboard apparatus of an electronic musical instrument according to claim 14, wherein
the plurality of keys are pivotably supported by a plurality of supporting portions provided on an upper surface of the frame, respectively;
the upper limit stopper member is fixed to an undersurface of the frame;
the frame has a plurality of penetrating holes through which the plurality of massive bodies pass; and
the each massive body is situated below the frame in a state where a key corresponding to the each massive body has been released, while the each massive body is displaced upward to be situated above the frame through the penetrating hole corresponding to the each massive body when the key corresponding to the each massive body is depressed.

16. A keyboard apparatus of an electronic musical instrument according to claim 15, wherein
the upper limit stopper member is shaped like a ribbon whose longitudinal direction coincides with a direction in which the plurality of keys are arranged, and continuously extends over at least two neighboring keys to be fixed to the undersurface of the respective fixing portions provided for the at least two keys.

17. A keyboard apparatus of an electronic musical instrument according to claim 15, wherein
the each massive body is designed such that an upper portion of the each massive body is situated inside right and left side walls of the key corresponding to the each massive body in a state where the corresponding key has been depressed.

18. A keyboard apparatus of an electronic musical instrument according to claim 14, wherein
on the upper surface of the frame, a plurality of vertical ribs are provided, the plurality of vertical ribs being situated on a plurality of positions with which the plurality of massive bodies come into contact, respectively.

19. A keyboard apparatus of an electronic musical instrument according to claim 15, wherein
on the upper surface of the frame, a plurality of vertical ribs are provided, the plurality of vertical ribs being situated on a plurality of positions with which the plurality of massive bodies come into contact, respectively; and
each of the vertical ribs is formed integrally with the each supporting portion.

20. A keyboard apparatus of an electronic musical instrument according to claim 14, wherein
the each massive body has a concave portion which is open downward such that a ceiling surface of the concave portion serves as the second contact portion to come into contact with the lower limit stopper member in a state where the corresponding key has been released.
